(19) United States
(12) Patent Application Publication
(10) Pub. No.: US 2008/0054714 A1
(43) Pub. Date: Mar. 6, 2008

(54) Variable trackwidth disc assembly for use with a wheel

(75) Inventor: Russell Kenneth Morrow, Tinley Park, IL (US)

Correspondence Address: MCANDREWS HELD & MALLOY, LTD, 500 WEST MADISON STREET, SUITE 3400, CHICAGO, IL, 60661, US

(73) Assignee: GKN Armstrong Wheels Inc.

(21) Appl. No.: 11/511,975

(22) Filed: Aug. 29, 2006

(51) Int. Cl. B60B 3/10

(52) U.S. Cl. 301/63.101

(57) ABSTRACT

A disc configured to be secured to a wheel rim through a flange ring at a variety of positions may include a base, a plurality of first securing members, and a plurality of second securing members. The base may be integrally formed with a circumferential wall. The plurality of first securing members extend from the circumferential wall at a first height from the base. The plurality of second securing members extend from the circumferential wall at a second height from the base, wherein the second height is different from the first height.

### FIELD OF THE INVENTION

Embodiments of the present invention generally relate to a disc assembly, and more particularly to a variable trackwidth disc assembly that may be used with wheels of various off-highway vehicles.

### BACKGROUND OF THE INVENTION

Agricultural fields typically include rows of crops spaced apart from one another a certain distance. Rows of different types of crops may be spaced at varying distances from one another for reasons related to productivity and fertility.

Various types of agricultural vehicles, such as plows, combines, tractors, and the like, have wheels that may be either fixed or adjustable. Typical wheel assemblies include a rim and a disc. The disc is the attachment point for the wheel assembly and typically connects to an axle hub or spindle hub. The rim is designed to support and maintain air pressure for the tire and connects to the disc. If the spacing between the fixed disc and the rim centerline is to be changed, a different wheel assembly with a different offset is required.

Instead of having three of four different sets of wheels that provide for different trackwidths or wheel offsets, an adjustable wheel assembly may be used. The disc of an adjustable wheel may be secured to the rim with one or more spacers sandwiched between the disc and the rim. In order to change the spacing, the disc is unbolted from the rim, and spacers are either added or removed between the disc and the rim in order to change the spacing. Typically, the wheel assembly includes a flange ring positioned between the wheel rim and the disc. The spacer(s) may fit between the flange ring and the lip of the disc. The spacers, however, may be misplaced, lost, or damaged through normal wear and tear. Moreover, when changing the offset of the wheel, one typically needs to account for the spacers and ensure that the spacers are properly secured within the wheel assembly. The cyclical loading of the wheels with spacers may result in loosening of bolts, which typically then need to be re-tightened. As such, adjusting and monitoring the wheel in the field may be tedious and difficult.

Further, spacers represent additional components that add cost to the manufacturing process of the wheel assembly. That is, the spacers are tooled, purchased, and handled separately, thereby adding time and cost to the manufacturing process.

Instead of using spacers, one type of adjustable wheel assembly includes a multi-surfaced flange ring secured within the rim. The flange ring includes a series of alternating surfaces incorporating the spacer functionality within the flange ring. The difference in height between the raised portions and the lowered portions of the flange ring incorporates the thickness of the spacers into the flange and provides an interface that allows one to change the offset of the rim with respect to the wheel centerline.

The cost of manufacturing a multi-surfaced flange ring is expensive when compared with the cost of manufacturing a conventional flange ring. Additional manufacturing steps or specialized stamping dies are needed to provide the raised portions of the multi-surfaced flange ring.

Moreover, a typical flange ring is small in relation to the disc and the rim. Once the flange ring is formed, the various stresses and strains exerted on it through the formation process may warp or disfigure the flange ring. In order to prevent the multi-surfaced flange ring from warping, bending, or the like, additional costly operations are added to the manufacturing process.

Thus, a need exists for a cost-effective, reliable wheel assembly that does not use separate spacers in order to vary the treadwidth.

### SUMMARY OF THE INVENTION

Certain embodiments of the present invention provide a wheel assembly that includes a rim, a flange ring, and a disc. The rim is configured to receive and retain a tire, and includes a first rim end and a second rim end connected by a central opening. The flange ring extends from the rim within the central opening, and may be offset from the center of the rim. The disc is configured to be removably secured to the flange ring. The disc includes a base at a first disc end, and a plurality of first and second securing members at a second disc end. The plurality of first securing members are in a first plane and the plurality of second securing members are in a second plane that differs from the first plane.

The disc is configured to secure to the flange ring in a first orientation through the plurality of first securing members when the first disc end is positioned through the first rim end before the second disc end. The disc is also configured to secure to the flange ring in a second orientation through the plurality of first securing members when the second disc end is positioned through the first rim end before the first disc end. Further, the disc may also be configured to secure to the flange ring in a third orientation through the plurality of second securing members when the first disc end is positioned through the second rim end before the second disc end. Additionally, the disc may be configured to secure to the flange ring in a fourth orientation through the plurality of second securing members when the second disc end is positioned through the second rim end before the first disc end. The disc is adjustable between the first, second, third and fourth orientations. For example, a user may remove the disc from the flange ring in any of the positions, and reposition the disc to a different orientation.

### BRIEF DESCRIPTION OF SEVERAL VIEWS OF THE DRAWINGS

FIG. 1 illustrates a top isometric view of a disc according to an embodiment of the present invention.

FIG. 2 illustrates a cross-sectional view of a disc through line 2-2 of FIG. 1 according to an embodiment of the present invention.

FIG. 3 illustrates an isometric exploded view of a wheel assembly according to an embodiment of the present invention.

FIG. 4 illustrates a sectional view of a wheel assembly in a first configuration according to an embodiment of the present invention.

FIG. 5 illustrates a sectional view of a wheel assembly in a second configuration according to an embodiment of the present invention.

FIG. 6 illustrates a sectional view of a wheel assembly in a third configuration according to an embodiment of the present invention.

FIG. 7 illustrates a sectional view of a wheel assembly in a fourth configuration according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

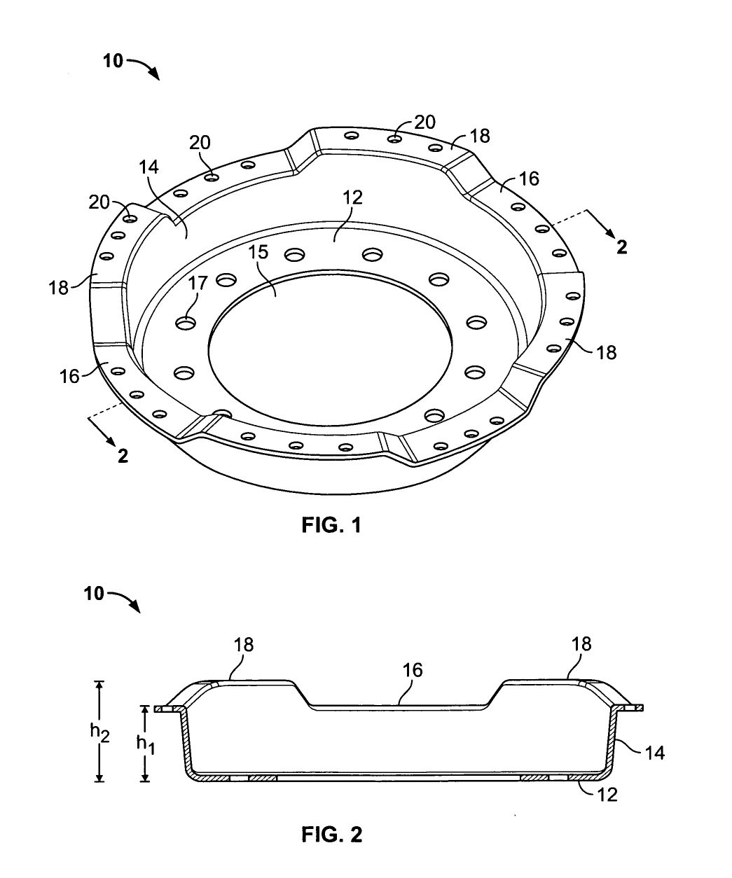

FIG. 1 illustrates a top isometric view of a disc 10 according to an embodiment of the present invention. The disc 10 includes a base 12 integrally formed with an upstanding circumferential wall 14. As shown in FIG. 1, the disc 10 may be circular. Further, the base 12 and the circumferential wall 14 may form a pan-like configuration. The base 12 may include a central opening 15 and fastener through-holes 17 that allow the disc to be secured to an axle assembly.

A series of securing ledges, tabs, areas, surfaces, flaps, wings, or the like 16 and 18 extend outwardly from the upstanding wall 14. The securing ledges 16 are lower than the ledges 18. For example, the securing ledges 16 are positioned at a first height above the base 12, while the securing ledges 18 are at a second height above the base 12. The securing ledges 16 may be in a first plane, while the securing ledges 18 may be in a second plane. The difference in height between the securing ledges 16 and 18 allows the disc to be secured to the rim, as discussed below, at different positions.

The disc 10 may include more or less securing ledges 16 and 18 than those shown in FIG. 1. Further, the securing ledges 16 and 18 may be at different heights than those shown in FIG. 1. Also, additional securing ledges at different heights may be used. For example, a first set of ledges may be at a first height, a second set of ledges may be at a second height, a third set of ledges may be at a third height, etc.

Each securing ledge 16 and 18 includes a plurality of fastener through-holes 20 formed therethrough. The fastener through-holes 20 allow the disc 10 to be secured to a rim, such as through bolts, screws, or the like. While each securing ledge 16 and 18 includes three fastener through-holes 20, more or less through-holes 20 than those shown in FIG. 1 may be used.

As shown in FIG. 1, the disc may be “waved,” such that the securing ledges 18 are high points, while the securing ledges 16 are low points. The waved nature of the disc 10 may provide additional strength and rigidity to the disc 10. That is, the alternating height of the ledges 16 and 18 may provide added rigidity to the disc 10 and act to brace and support the disc 10.

FIG. 2 illustrates a cross-sectional view of the waved disc 10 through line 2-2 of FIG. 1. As shown in FIG. 2, the securing ledges 16 are at a first height h¹ above the base 12, while the securing ledges 18 are at a second height h² above the base 12. As noted above, additional securing ledges set at different heights with respect to the base 12 may be used in addition to, or in lieu of, the securing ledges 16 and 18.

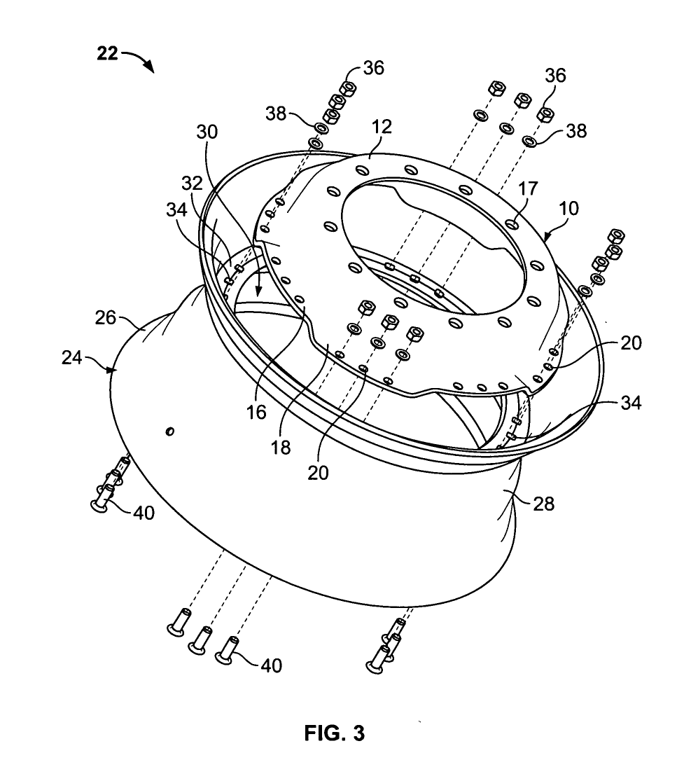

FIG. 3 illustrates an isometric exploded view of a wheel assembly 22 according to an embodiment of the present invention. The wheel assembly 22 includes a rim 24 configured to be secured to the waved disc 10 in a variety of configurations.

The rim 24 includes an hour-glass main body 26 having a circumferential wall 28. An outer surface of the circumferential wall 28 is configured to receive and retain a tire (not shown). A central opening 30 is formed through the rim 24. The waved disc 10 is configured to be secured to a flange ring 32 within the rim 24.

The flange ring 32 extends inwardly from the circumferential wall 28 within the central opening 30. The flange ring 32 may be integrally formed with the rim 24, or the flange ring 32 may be separately secured to the rim 24, such as through bonding or welding. The flange ring 32 includes a plurality of fastener through-holes 34 configured to align with the fastener through holes 20 of the waved disc 10. The ledges 16 and 18 are configured to abut against the flange ring 32 such that the fastener through-holes 20 align with the fastener through-holes 34. Once the fastener through holes 20 and 34 are aligned, the waved disc 10 may be secured to the flange ring 32, and therefore the rim 24, through fasteners such as nuts 36, washers 38, and bolts 40. Optionally, various other fasteners may be used instead of the nuts and bolts shown. For example, screws, latches, clasps, or the like may be used to secure the waved disc 10 to the rim 24.

Because the ledges 16 and 18 of the waved disc 10 are at different heights with respect to one another, the waved disc 10 may be secured within the rim 24 at different positions. That is, securing the waved disc 10 to the flange ring 32 through the ledges 16 locates the waved disc 10 at a first position with respect to the rim 24; while securing the waved disc 10 to the flange ring 32 through the ledges 18 locates the waved disc 10 at a second position with respect to the rim 24. As such, the position of the wheel assembly 22 with respect to the axle assembly (not shown) may be changed between various positions. That is, the offset of the wheel assembly 22 with respect to the axle assembly may be adjusted to different positions, depending on the preferences of a particular user.

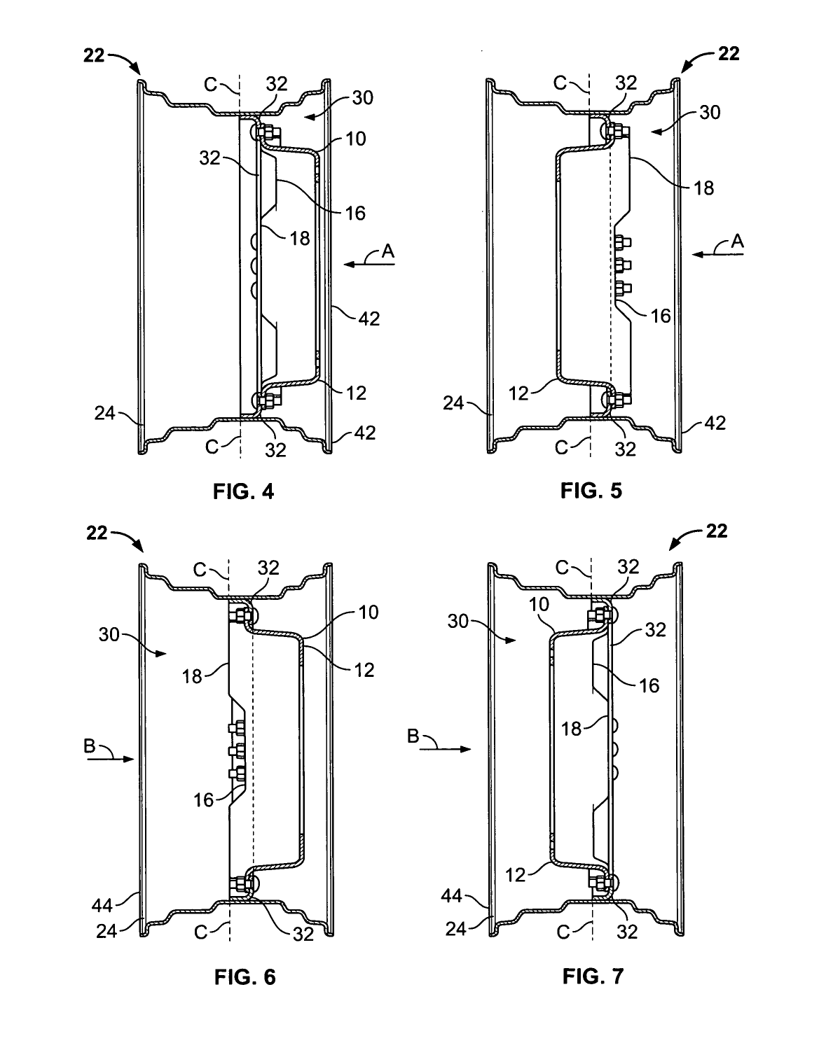

FIG. 4 illustrates a sectional view of the wheel assembly 22 in a first configuration. As shown in FIG. 4, the disc 10 is urged through a first end 42 of the rim 24 into the central opening 30 in the direction of arrow A so that the ledges 16 and 18 are moved into the central opening 30 before the base 12. The ledges 18 engage the flange ring 32 and are secured to the flange ring 32 through fasteners. Thus, the disc 10 may be secured to the rim 24 in a first orientation.

FIG. 5 illustrates a sectional view of the wheel assembly 22 in a second configuration. As shown in FIG. 5, the disc 10 is urged through the first end 42 of the rim 24 into the central opening 30 in the direction of arrow A so that the base 12 is moved into the central opening 30 before the ledges 16 and 18. The flange ring 32 is configured to allow the base 12 to pass therebetween. However, as the base 12 moves between the flange ring 32, the ledges 16 abut against the flange ring 32. The through-holes of the flange ring 32 and the through-holes of the ledges 16 are aligned, and fasteners are positioned therethrough to secure the disc 10 to the rim 24 in a second orientation. As shown in FIG. 5, the second orientation is different from the first orientation (shown in FIG. 4) and allows the wheel assembly 22 to be positioned at a different position with respect to an axle assembly (not shown).

FIG. 6 illustrates a sectional view of the wheel assembly 22 in a third configuration. As shown in FIG. 5, the disc 10 is urged through a second end 44 of the rim 24 into the central opening 30 in the direction of arrow B so that the base 12 is moved into the central opening 30 before the ledges 16 and 18. The flange ring 32 is configured to allow the base 12 to pass therebetween. However, as the base 12 moves between the flange ring 32, the ledges 16 abut against the flange ring 32. The through-holes of the flange ring 32 and the through-holes of the ledges 16 are aligned, and fasteners are positioned therethrough to secure the disc 10 to the rim 24 in a third orientation. As shown in FIG. 6, the third position is different from the first and second orientations (shown in FIGS. 4 and 5, respectively) and allows the wheel assembly 22 to be positioned at a different position with respect to an axle assembly (not shown).

FIG. 7 illustrates a sectional view of the wheel assembly 22 in a fourth configuration. As shown in FIG. 7, the disc 10 is urged through the second end 44 of the rim 24 into the central opening 30 in the direction of arrow B so that the ledges 16 and 18 are lead into the central opening 30 before the base 12. The ledges 18 engage the flange ring 32 and are secured to the flange ring 32 through fasteners. Thus, the waved disc 10 is secured to the rim 24 in a fourth orientation.

As shown in FIGS. 4-7, the flange ring 32 extends into the central opening at such that the flange ring 32 offset from the center C of the rim 24. As such, the first configuration differs from the fourth configuration. Moreover, the third configuration is different from the second configuration. The flange ring 32 may be positioned at various positions with respect to the rim 24. However, positioning the flange ring 32 at the center C of a symmetrical rim may provide two wheel configurations. Because the flange ring 32 is offset from the center C, urging the waved disc 10 into the rim 24 from different ends 42 and 44 provides additional configurations.

Referring to FIGS. 4-7, in order to switch between configurations, a user unfastens the disc 10 from the rim 24, and secures it in another configuration. For example, if the wheel assembly 22 is in the first configuration shown in FIG. 4, a user unbolts the disc 10 from the flange ring 32. If the user prefers the fourth configuration, the user removes the disc 10 from the rim 24 through the first end 42 of the rim 24. The user may then flip the disc 10 around and urge it through the second end 44 of the rim 24 until the securing ledges 18 abut against the flange ring 32. The waved disc 10 may then be secured to the flange ring 32, as discussed above.

Overall, embodiments of the present invention provide a durable wheel assembly that may be easily switched between a variety of configurations. Embodiments of the present invention provide a disc assembly that may be used with a wheel of agricultural equipment in order to selectively change the treadwidth of the wheel base. Certain embodiments of the present invention provide a cost-effective, reliable wheel assembly that does not use separate spacers in order to provide different wheel configurations. Instead of using a multi-surfaced flange ring that is relatively expensive to manufacture and susceptible to warping, embodiments of the present invention provide a strong, durable disc that allows for a variety of wheel configurations.

Additionally, the waved disc may be used with a multi-surfaced flange ring to provide even more configurations.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A wheel assembly comprising:
a rim configured to receive and retain a tire, said rim having a central opening;
a flange ring extending from said rim within said central opening; and
a disc configured to be removably secured to said flange ring, said disc comprising first and second securing members, said first securing member being in a different plane than said second securing member, said disc being configured to secure to said flange ring in at least a first orientation through said first securing member, and said disc being configured to secure to said flange ring in at least a second orientation through said second securing member.

2. The wheel assembly of claim 1, wherein said disc is adjustable between said first and second orientations.

3. The wheel assembly of claim 1, wherein each said first and second securing members comprises a ledge.

4. The wheel assembly of claim 1, further comprising a plurality of said first securing members and a plurality of said second securing members.

5. The wheel assembly of claim 1, wherein said disc is configured to removably secure to said flange ring in at least four different orientations.

6. The wheel assembly of claim 1, wherein said flange ring is offset from a center of said rim.

7. The wheel assembly of claim 1, wherein said disc further comprises a base integrally formed with a circumferential wall, wherein said first and second securing members extend from said circumferential wall, and wherein the plane of said first securing member is a first distance from the plane of said base, and the plane of said second securing member is a second distance from the plane of said base.

8. A wheel assembly comprising:
a rim configured to receive and retain a tire, said rim having a first rim end and a second rim end connected by a central opening;
a flange ring extending from said rim within said central opening; and
a disc configured to be removably secured to said flange ring, said disc comprising a base at a first disc end, and a plurality of first securing members and a plurality of second securing members at a second disc end, said plurality of first securing members being in a first plane and said plurality of second securing members being in a second plane that differs from the first plane.

9. The wheel assembly of claim 8, wherein said disc is configured to secure to said flange ring in a first orientation through said plurality of first securing members when said first disc end is positioned through said first rim end before said second disc end.

10. The wheel assembly of claim 9, wherein said disc is configured to secure to said flange ring in a second orientation through said plurality of first securing members when said second disc end is positioned through said first rim end before said first disc end.

11. The wheel assembly of claim 10, wherein said disc is configured to secure to said flange ring in a third orientation through said plurality of second securing members when said first disc end is positioned through said second rim end before said second disc end.

12. The wheel assembly of claim 11, wherein said disc is configured to secure to said flange ring in a fourth orientation through said plurality of second securing members when said second disc end is positioned through said second rim end before said first disc end.

13. The wheel assembly of claim 12, wherein said disc is adjustable between said first, second, third and fourth orientations.

14. The wheel assembly of claim 8, wherein each said plurality of first securing members and said plurality of second securing members comprises a ledge.

15. The wheel assembly of claim 8, wherein said flange ring is offset from a center of said rim.

16. A disc configured to be secured to a wheel rim through a flange ring at a variety of positions, the waved disc comprising:
a base integrally formed with a circumferential wall;
a plurality of first securing members extending from said circumferential wall at a first height from said base; and
a plurality of second securing members extending from said circumferential wall at a second height from said base, wherein the second height is different from the first height.

17. The disc of claim 16, wherein each said plurality of first securing members and said plurality of second securing members comprises a ledge.

18. The disc of claim 16, wherein the disc is configured to secure to the flange ring in at least four different orientations.

19. The disc of claim 16, wherein the disc is configured to be adjustable between the at least four different orientations.

20. The disc of claim 16, wherein the disc is also configured to secure to an axle assembly.
